(19) United States
(12) Patent Application Publication
(10) Pub. No.: US 2015/0298126 A1
(43) Pub. Date: Oct. 22, 2015

(54) Cartridge having Electrical Sliding Contact, and Method

(71) Applicant: Robert Bosch GmbH, Stuttgart (DE)

(72) Inventors: Melanie Hoehl, Ditzingen (DE); Arne Dannenberg, Metzingen (DE); Juergen Steigert, Stuttgart (DE)

(21) Appl. No.: 14/647,889

(22) PCT Filed: Nov. 21, 2013
(86) PCT No.: PCT/EP2013/074332

§ 371 Date: May 28, 2015

(30) Foreign Application Priority Data
Nov. 28, 2012 (DE) 10 2012 221 734.7

(51) Int. Cl. B01L 3/00

(52) U.S. Cl. CPC B01L 3/50825; B01L 2200/10; B01L 2300/06; B01L 2400/0409

(57) ABSTRACT

A cartridge includes a drum that has at least one chamber and electrical contact elements, an adjusting device that is configured to rotate the drum about a center axis of the drum, and electrical conducting tracks on a housing of the cartridge. The electrical contact elements are brought into sliding contact with the electrical conducting tracks in order to transmit electrical energy.

### PRIOR ART

Biochemical processes are carried out on the basis, in particular, of the handling of liquids. This handling is typically carried out manually using aids, such as pipettes, reaction vessels, active probe surfaces or laboratory equipment. These processes are already automated in part by pipetting robots or by special equipment.

Lab-on-a-chip systems place the entire functionality of a macroscopic laboratory on a plastics substrate which is merely the size of a plastic card. Lab-on-a-chip systems typically consist of two main components. A test substrate contains structures and mechanisms for implementation of basic fluid operations (for example mixers), which may consist of passive components, such as ducts, reaction chambers and upstream reagents, or of active components, such as valves or pumps. The second main components are actuation, detection and control units. Systems of this kind make it possible to carry out biochemical processes in a fully automated manner.

A lab-on-a-chip system is described, for example, in document DE 10 2006 003 532 A1. This system comprises a rotor chip, which can rotate in relation to a stator chip. The rotor chip can be coupled by means of fluidic ducts to the stator chip for filling or emptying the rotor chip.

### Advantages of the Invention

The cartridge defined in claim 1 and the method defined in claim 14 have the advantage over conventional solutions that electrical energy can be transmitted from a power source to an electrical load in the drum which rotates during operation of the cartridge. Therefore, a large number of different devices, such as a heater, a sensor or semiconductor components for example, can be operated during the centrifuging of the cartridge and therefore different processing steps, measurement and analysis methods for the component which is to be examined can be realized, wherein the devices are switched on and switched off depending on the respectively acting centrifugal force. As an alternative to this, the structures of the present cartridge can also be transmitted to externally pressure-actuated systems in an identical manner. The present method additionally has the advantage that it is possible to supply electrical power to a load (such as a sensor or a heating apparatus for example) in the rotating drum during centrifuging of the cartridge without the use of cables. Furthermore, the inventive transmission of the electrical energy from the power source to the load in the drum permits a simple structural design for the power line and the interface of said power line between the housing of the cartridge and the drum, as a result of which the costs for the cartridge can advantageously be kept low.

The present cartridge is advantageously independent of an external power supply for the operation of the devices, and therefore the extended functionality of the cartridge in connection with the devices is further available with existing centrifuges, and therefore retrofitting of the centrifuges is unnecessary.

If the cartridge has more than one drum, each drum can be provided with an individual device, which is in turn separately activated and controlled, in the case of the present cartridge.

The present cartridge advantageously provides an autonomous system for processing a component, in which system the respectively running processes are carried out in a drum with the aid of the devices, and therefore are independent of a supply with energy and/or information from outside the cartridge.

The arrangement of the device in the interior of the drum ensures immediate processing of the component and therefore rapid changes in the respective constituent parts of the component.

Since the control unit for the device is provided in the cartridge, processing can be carried out in a simple manner, and therefore it is advantageously possible to dispense with presetting operating parameters.

The power supply source can be easily disconnected from the cartridge and disposed of in a simple manner after the analysis of the component has been carried out.

Advantageous refinements of the invention can be found in the dependent claims.

In the present case, “component” means a liquid, a gas or a particle (or a plurality of particles). The “first and second components” can also mean merely two different states of the same substance: for example, the first component can be in the form of a clumped portion and the second component can be in the form of a liquid portion of the same substance.

According to a further refinement of the cartridge according to the invention, the electrical contact elements are electrically conductively connected to a semiconductor component on a printed circuit board which is coupled to the drum. The printed circuit board preferably contains electrically functional structures, such as a heating resistor, in particular one which is arranged in a meandering manner, or a temperature-dependent resistor for example. The semiconductor element may be, for example, a temperature sensor to which power is supplied by the closed electrical circuit for carrying out a temperature measurement. The semiconductor element may also be a chemical FET or an amperometric sensor.

According to a further refinement of the cartridge according to the invention, the semiconductor component can be actuated with the aid of a microcontroller in the closed state of the electrical contact elements with the electrical conductor tracks. As an alternative to this, a microprocessor or a microchip can also be used. The microcontroller, microprocessor or microchip all contain circuit logic systems for carrying out an open-loop control operation or a closed-loop control operation on the semiconductor component while the electrical circuit within the cartridge is closed.

According to a further refinement of the cartridge according to the invention, in the closed state of the electrical contact elements with the electrical conductor tracks, the actuation of the semiconductor component by the microcontroller produces variable output of electrical energy to the semiconductor component. Therefore, the electrical energy can be provided to the semiconductor element in the case of a closed electrical circuit not only constantly, but also in a controlled or triggered manner.

According to a further refinement of the cartridge according to the invention, the semiconductor component is a heating device, which is provided in the drum, for, in particular cyclical, heating of the chamber which can be switched for heating purposes by means of the electrical contact elements making contact with the electrical conductor tracks. As a result, the heating device can provide, for example, the necessary temperature profile in the chamber of the drum, so that a polymerase chain reaction can take place in a component in the chamber.

According to a further refinement of the cartridge according to the invention, electrical conductor tracks are arranged on the inside of the housing. In this case, the electrical conductor tracks can be arranged so as to run in the interior of the wall of the housing or on the inner surface of the housing.

According to a further refinement of the cartridge according to the invention, the electrical conductor tracks are in the form of an injection-molded circuit mount (MID) in the housing of the cartridge. The MIDs (molded interconnect devices) are preferably formed on the inner face of the housing. The MIDs are further connected to an energy source for supplying electrical energy to the cartridge.

According to a further refinement of the cartridge according to the invention, the printed circuit board further has at least two tabs at its ends, one electrical contact element being formed on said tabs in each case, wherein a first pair of electrical conductor tracks can make contact with the electrical contact elements. The two tabs are preferably arranged opposite one another at the end regions of the printed circuit board. The electrical contact element is preferably an electrically conductive coating in the region of the tab of the printed circuit board.

According to a further refinement of the cartridge according to the invention, the printed circuit board has further tabs, one electrical contact element once again being formed on said tabs in each case, wherein electrical conductor tracks which are different from the first pair of electrical conductor tracks can make contact with these electrical contact elements. The use of more than two tabs allows various functions to be switched at different times on the same printed circuit board. In this case, the further tabs are preferably in contact with electrical conductor tracks which are different from the first pair of electrical conductor tracks.

According to a further refinement of the cartridge according to the invention, the electrical conductor tracks can be connected to an energy source in a wire-bound manner or in a wire-free manner, in order to, in the closed state of the electrical contact elements with the electrical conductor tracks, generate a flow of current through said electrical conductor tracks. Wire-free solutions can make use of coils, a battery or a rechargeable battery in the cartridge.

According to one refinement of the cartridge according to the invention, the adjustment device comprises a first bevel which interacts with a second bevel of the drum in order to move the drum from a first position, in which the second bevel engages in an interlocking manner with a housing of the cartridge in the direction of rotation about the center axis, to a second position along the center axis in which the interlocking connection is broken and the drum rotates about the center axis. This mechanism is also called a “ballpoint pen mechanism” in the present case.

According to a further refinement of the cartridge according to the invention, the electrical conductor tracks are formed on the adjustment device instead of on the housing of the cartridge. In this case, the electrical conductor tracks are preferably arranged in the region of the first bevel of the adjustment device and are electrically connected to the energy source for supplying electrical energy to the cartridge, so that the electrical contact elements of the drum close the electrical circuit in a suitable position of the drum.

According to a further refinement of the cartridge according to the invention, the electrical contact elements of the drum are second electrical conductor tracks which are electrically conductively connected to the semiconductor component on the printed circuit board.

### BRIEF DESCRIPTION OF THE DRAWING

Exemplary embodiments of the invention are illustrated in the figures of the drawing and are explained in greater detail in the following description.

In the drawings:

FIG. 1 shows a perspective view of a cartridge, without a drum, according to one exemplary embodiment of the present invention;

FIG. 2 shows a perspective view of the opening region of the cartridge from FIG. 1;

FIG. 3 shows a drum of the cartridge from FIG. 1 in the form of a rotary turret;

FIG. 4 shows a side view of the drum from FIG. 3;

FIG. 5 shows a partial view of a contact-free state between electrical contact elements of a printed circuit board and of the cartridge from FIG. 1;

FIG. 6 shows a partial view of a contact state between electrical contact elements of a printed circuit board and of the cartridge from FIG. 1;

FIG. 7 shows a schematic illustration of a sliding contact for a cartridge according to a further exemplary embodiment of the invention;

FIG. 8 shows a schematic illustration of a sliding contact for a cartridge according to a yet further exemplary embodiment of the invention;

FIG. 9 schematically shows a view of a printed circuit board with a heating device for a cartridge according to a yet further exemplary embodiment of the present invention; and

FIG. 10 schematically shows a view of a printed circuit board with a closed-loop control system for a heating device for a cartridge according to a yet further exemplary embodiment of the present invention.

In the figures, identical or functionally identical elements are denoted using the same reference symbols, unless stated otherwise.

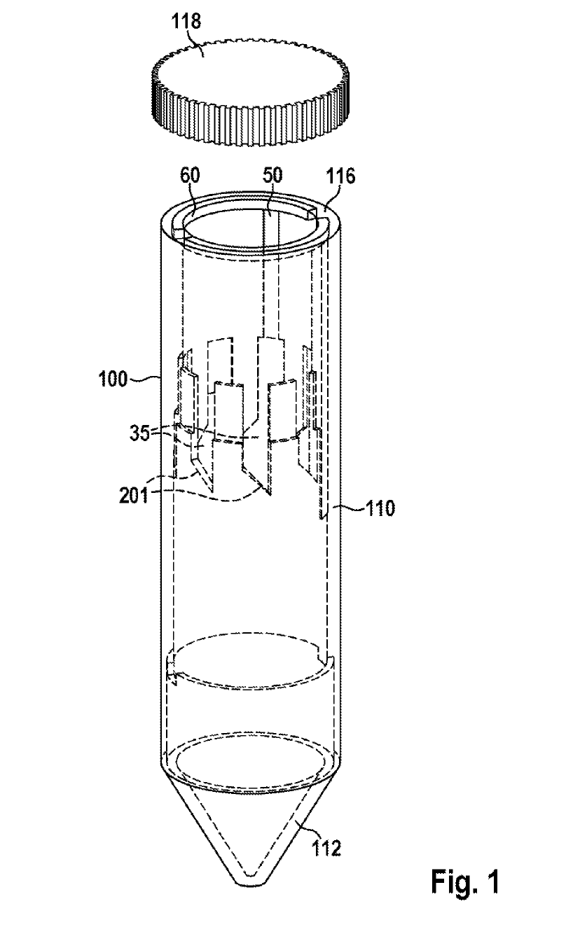

FIG. 1 shows a perspective view of a cartridge 100, without a drum, according to one exemplary embodiment of the present invention.

The cartridge 100 comprises a housing 110 in the form of a tube. By way of example, the housing 110 may be in the form of a 5 to 100 ml, in particular 50 ml, centrifugal tube, a 1.5 ml or 2 ml Eppendorf tube or, as an alternative, in the form of a microtiter plate (for example 20 μl per cavity).

By way of example, a drum (not illustrated) is accommodated in the housing 102.

The housing 110 is closed at one end 112 thereof. The other end 116 of the housing 110 is closed off by means of a closure 118. The closure 118 can preferably be taken off in order to remove the drum from the housing 110. As an alternative, the housing 110 itself can also be dismantled in order to remove the drum or to reach a chamber (not illustrated) in the drum.

The closure 118 is preferably designed for supplying energy for the drum, wherein the energy supply can be designed as a reusable component or device which, during operation of the cartridge 100, is a constituent part of said cartridge. For example, the closure 118 can be provided with an integrated rechargeable battery (not illustrated) or a battery (not illustrated) in a removable manner.

The housing 110 and the drum 10 can be produced from the same polymer or from different polymers. The one or more polymers are, in particular, thermoplastics, elastomers or thermoplastic elastomers. Examples include cyclo-olefin polymer (COP), cyclo-olefin copolymer (COC), polycarbonates (PC), polyamides (PA), polyurethanes (PU), polypropylene (PP), polyethylene terephthalates (PET) or polymethyl methacrylates (PMMA).

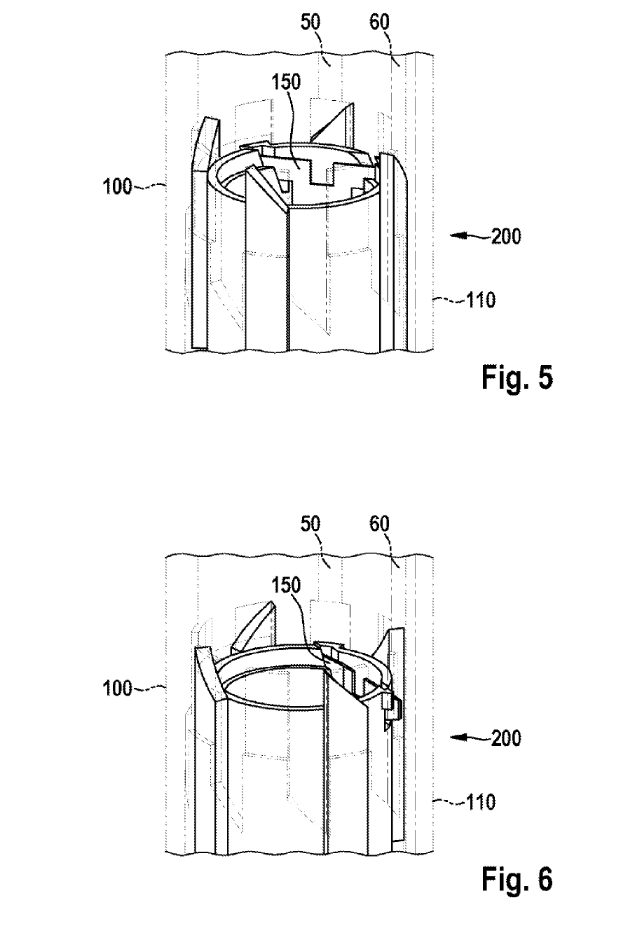

Electrical conductor tracks 50, 60, preferably in the form of an injection-molded circuit mount (MID), are formed in the region of the inner face of the housing 110 of the cartridge 100. A region of the electrical conductor tracks 50, 60 runs in each case in the region of the open end 116 of the cartridge 100, and therefore serves as an interface for contact to be made by the energy supply of the closure 118. In the cylindrical region of the housing 110, the electrical conductor tracks 50, 60 extend substantially in the vertical direction toward the end 112 as far as a predetermined length which is defined by a large number of teeth 35, which are arranged in a manner spaced apart at regular intervals over the circumference, of an adjustment device (see FIGS. 5 and 6 in this respect). The electrical conductor tracks 50, 60 are electrically connected to selected teeth 35 of the adjustment device. The bottom of the teeth 35 each have a first bevel 201.

The electrical conductor tracks 50, 60 are preferably molded in, for example using an injection-molding process, during the manufacturing process of the drum 10. The electrical conductor tracks 50, 60 can also be coated with a protective layer. The electrical conductor tracks 50, 60 typically have a thickness of a few nanometers (for example 50 nm) up to a few millimeters (for example 3 mm) or can also be designed as wires. The width of the electrical conductor tracks 50, 60 can vary from a few micrometers to a few millimeters. The electrical conductor tracks 50, 60 can comprise metal materials, such as copper, gold, aluminum, platinum, titanium and alloys of said metals, or doped semiconductor materials, such as silicon.

When the closure 118 is screwed onto the cartridge 100, an electrical circuit is established by contact springs (not illustrated) in the closure 118 and in the electrical conductor tracks 50, 60.

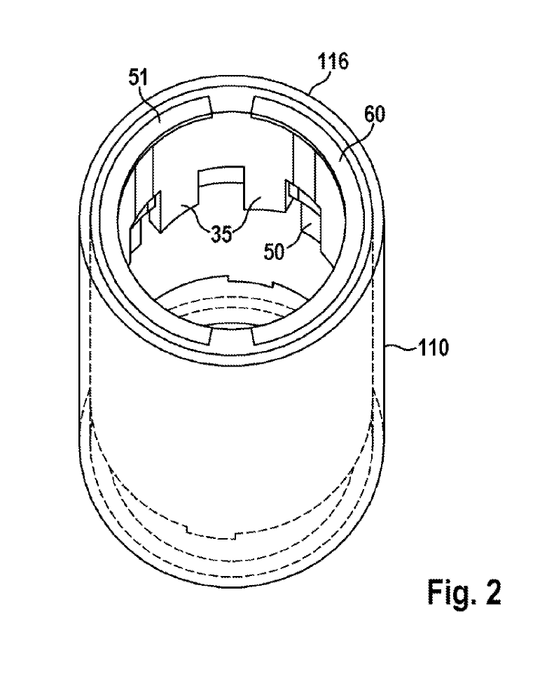

FIG. 2 shows a perspective view of the opening region 116 of the cartridge 100 from FIG. 1.

A region 51 of the electrical conductor tracks 50, 60 runs in each case in the region of the open end 116 of the cartridge 100, and therefore serves as an interface for contact to be made by the energy supply of the closure 118.

As shown in FIG. 2, the teeth 35 are formed on the inside of the housing 110 of the cartridge 100 and are offset in the depth direction of the housing 110.

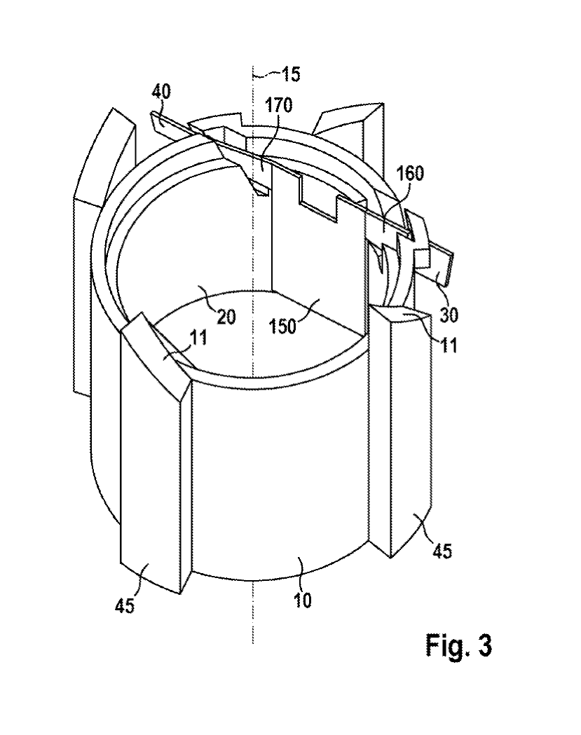

FIG. 3 shows a drum 10 for the cartridge 100 from FIG. 1 in the form of a rotary turret. The drum 10 is a substantially thin-walled container which has, in its inner region, a chamber 20 for holding a component, for example a biological sample from a person, which sample is to be examined, or any chemical substance.

A printed circuit board 150, which is a substantially flat element, is arranged in an inner circumferential region of the chamber 20. The printed circuit board 150 has an approximately rectangular central region, wherein tabs 160, 170 in each case extend away from the central region in the region of the upper transverse end. The printed circuit board 150 is of mirror-symmetrical design. In each case one electrical contact element 30, 40, which is provided for sliding electrical contact with the electrical conductor tracks (not illustrated) of the cartridge 100, is formed in the region of the longitudinal ends of the tabs 160, 170. The printed circuit board 150 furthermore has electrically functional structures which may, for example, heat the component.

The chamber 20 can be provided with a thermal insulation, for example with the aid of phase-change materials, in the region of its inner circumferential face. As an alternative to this, the thermal insulation can be arranged entirely or partially in the outer circumferential region of the drum 10.

A large number of teeth 45 of an adjustment device (see FIGS. 5 and 6 once again in this respect), which teeth each extend along the entire height of the drum 10, are arranged at regular intervals in the region of the outer circumferential face of the drum 10. The bottom of the teeth 45 is flush with the bottom of the chamber 20. The teeth 45 each project by a predetermined height beyond the height of the drum 10, wherein the free end of the teeth 45 is in each case in the form of a bevel 47.

During operation, the drum 10 rotates about a center axis 15 which is identical to the center axis of the cartridge (not illustrated).

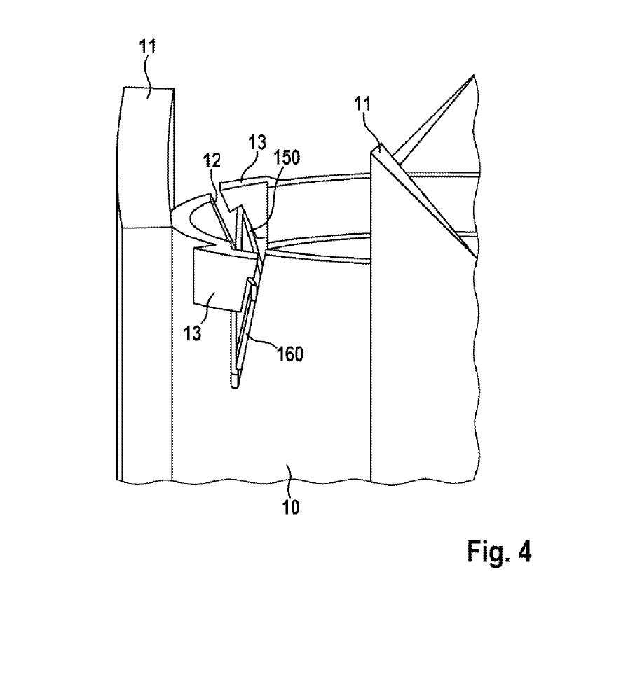

FIG. 4 shows a side view of the drum 10 from FIG. 3, wherein the drum 10 has slot-like recesses 12, which are in each case arranged opposite one another and which are provided for receiving the tabs 160, 170 of the printed circuit board 150, in the region of the upper end of the chamber 20. In each case one lug 13, which extends slightly at a distance from the outer circumferential face of the drum 10 in the circumferential direction, is formed opposite the slot-like recess 12 in the region of the upper end of the chamber 20. The lug 13, in conjunction with the slot-like recess 12, is provided for connection of the printed circuit board 150 to the drum 10, wherein the lug 13 engages behind in each case one section of the tabs 160, 170 after the tabs 160, 170 are inserted into the slot-like recess 12, and in this way produces an interlocking connection between the printed circuit board 150 and the drum 10.

In the installation position, the printed circuit board 150 is inclined in relation to a vertical plane, and therefore the tabs 160, 170 of the printed circuit board 150 additionally become jammed in the lugs 13.

This embodiment for fastening the printed circuit board 150 in the drum 10 can advantageously be established by means of injection molding, wherein a slide for undercuts can be dispensed with.

FIG. 5 shows a partial view of a contact-free state between the electrical contact elements 30, 40 of a printed circuit board 150 and of the cartridge from FIG. 1. An adjustment device 200 is formed in the interior of the cartridge 10 by the teeth which are formed on the drum 10 and the teeth which are formed on the inner circumferential region of the housing 110, said adjustment device causing the drum 10 to rotate through a predetermined angle in a predetermined direction in relation to the housing 110 of the cartridge 100 (′operation of the ballpoint pen mechanism′) when the adjustment device 200 is operated.

Since the electrical conductor tracks 50, 60 which are formed on the inside of the housing 110 of the cartridge 100 do not make contact with the respective electrical contact elements (not illustrated) of the printed circuit board 150, which electrical contact elements are in the form of sliding contacts, in the position according to FIG. 5, the electrical function on the printed circuit board 150 cannot be activated in this position. Instead, the electrical contact elements of the printed circuit board 150 are rotated in relation to the electrical conductor tracks 50, 60. It is possible to close the electrical circuit within the cartridge 100 only after further operation of the adjustment device 200.

FIG. 6 shows a partial view of a contact state between the electrical contact elements 30, 40 of a printed circuit board 150 and the cartridge from FIG. 1. In the position according to FIG. 6, the drum is further rotated by one tooth position in relation to the position from FIG. 5, wherein the electrical conductor tracks 50, 60 are now in contact with the respective electrical contact elements (not illustrated) of the printed circuit board 150. The electrical circuit within the cartridge 100 is closed and electrical energy will now be supplied to the printed circuit board 150 for as long as this position is held, until the adjustment device 200 is operated again. Therefore, the electrical function on the printed circuit board 150 is activated.

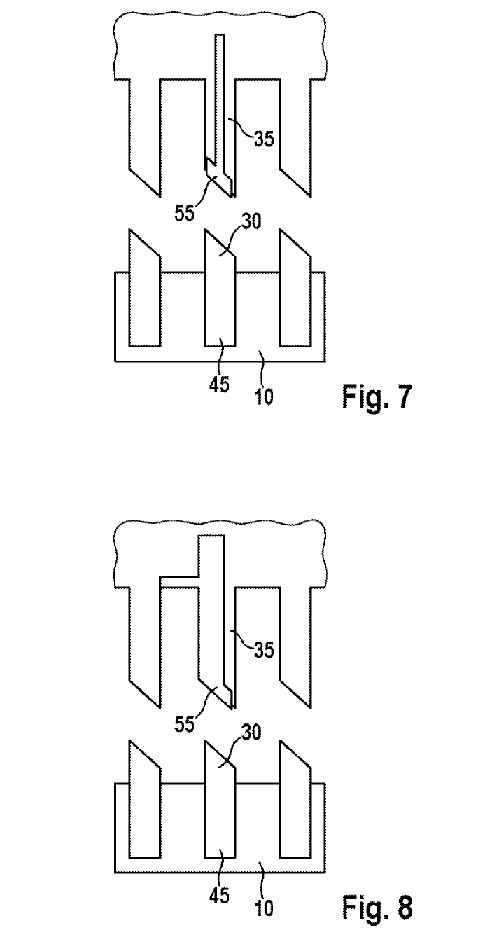

FIG. 7 shows a schematic illustration of a sliding contact for a cartridge according to a further exemplary embodiment of the invention.

In FIGS. 7 and 8, a large number of teeth, which can be associated with the inner circumferential region of the housing of the cartridge (not illustrated), are illustrated in the upper region of said figures. Accordingly, a large number of teeth, which can be associated with the outer circumferential region of the drum 10, are illustrated in the lower region of FIGS. 7 and 8.

FIG. 7 shows a further embodiment for the arrangement of the electrical conductor track 30 for supplying power to a printed circuit board (not illustrated) of the drum 10. The views in FIGS. 7 and 8 each show only one electrical conductor track 30, while the associated second electrical conductor track (not illustrated) is arranged opposite said electrical conductor track.

An electrical contact 55 in the form of an injection-molded circuit mount (MID) on the housing of the cartridge is formed on the surface of a tooth 35. In the region of the free end of the tooth 35, the electrical contact 55 has a shape which is substantially identical to that of the tooth 35. The electrical contact 55 is electrically connected to an energy source (not illustrated) of the cartridge.

A coating for forming an electrical contact element is likewise applied to the surface of a tooth 45 of the drum 10 as an electrical conductor track 30, preferably in the form of an injection-molded circuit mount (MID), on the tooth 45. The electrical conductor track 30 is electrically connected to the printed circuit board of the drum 10, and therefore an electrical function (for example detection of a temperature or heating of a component in the drum 10 can be produced with the aid of said electrical conductor track. As soon as the electrical contact 55 of the cartridge comes into contact with the electrical conductor track 30 of the drum 10 when an adjustment device (not illustrated) is switched, the electrical circuit is closed and an electrical function is implemented in the drum 10.

FIG. 8 shows a schematic illustration of a sliding contact for a cartridge according to a yet further exemplary embodiment of the invention.

An electrical contact 55 in the form of an injection-molded circuit mount (MID) on the housing of the cartridge is formed on the surface of a tooth 35. In the region of the free end of the tooth 35, the electrical contact 55 has a shape which is substantially identical to that of the tooth 35. In addition to this, the electrical contact 55 is formed in the region between two adjacent teeth. The electrical contact 55 is electrically connected to an energy source (not illustrated) of the cartridge.

A coating for forming an electrical contact element is likewise applied to the surface of a tooth 45 of the drum 10 as an electrical conductor track 30, preferably in the form of an injection-molded circuit mount (MID), on the tooth 45. The electrical conductor track 30 is electrically connected to the printed circuit board of the drum 10, and therefore an electrical function (for example detection of a temperature or heating of a component in the drum 10 can be produced with the aid of said electrical conductor track. As soon as the electrical contact 55 of the cartridge comes into contact with the electrical conductor track 30 of the drum 10 when an adjustment device is switched, the electrical circuit is closed and an electrical function is implemented in the drum 10.

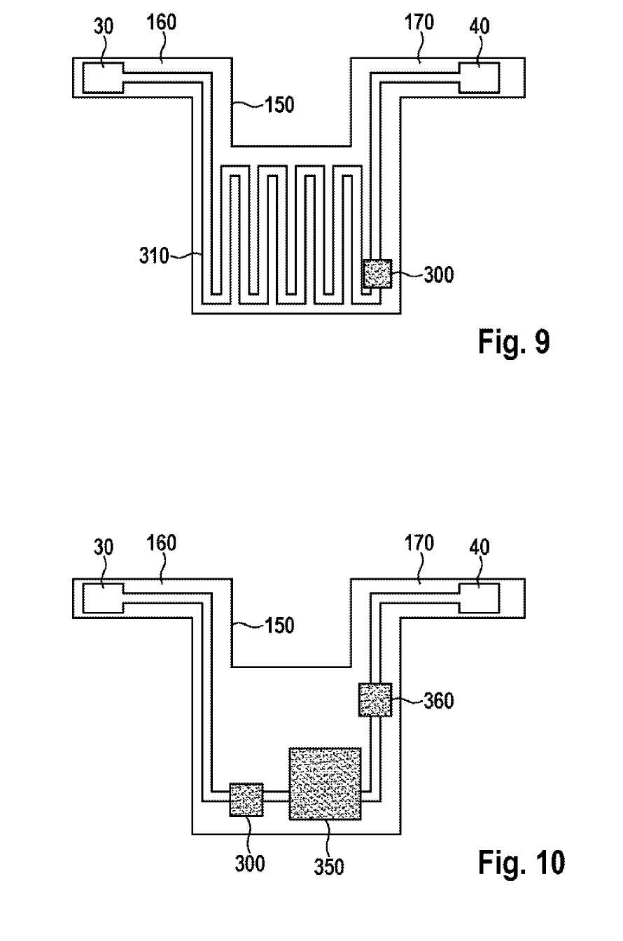

FIG. 9 schematically shows a view of a printed circuit board 150 with a heating device 310 for a cartridge according to a yet further exemplary embodiment of the present invention.

The printed circuit board 150 is a flat component and has one tab 160 and 170 in the upper region of each of its longitudinal ends. The heating device 310 for the printed circuit board 150 is in the form of a meandering heating means which extends substantially along the surface of one side of the printed circuit board 150 and, at its ends, is electrically connected to electrical contact elements 30, 40 in each case. A temperature-dependent resistor 300, which is arranged above the heating device 310, is arranged, as a semiconductor element, on the same side of the printed circuit board 150 as the heating device 310. The temperature-dependent resistor 300 can be used as a closed-loop control element for the temperature. Any other closed-loop control elements are possible as an alternative to this.

FIG. 10 schematically shows a view of a printed circuit board 150 with a closed-loop control system for a heating device 300, 350 for a cartridge according to a yet further exemplary embodiment of the present invention.

The printed circuit board 150 is once again a flat component and has one tab 160 and 170 in the upper region of each of its longitudinal ends. The closed-loop control system for the heating device comprises a temperature sensor 300 and an actuator 350 which is electrically connected to the temperature sensor 300 in series. The temperature sensor 300 and the actuator 350 are electrically connected to electrical contact elements 30, 40 which are once again formed in the upper region of the printed circuit board 150 with tabs 160 and 170 which are formed at the longitudinal ends of said printed circuit board in each case.

The temperature sensor 300 measures the temperature of a component (not illustrated), and the actuator 350 adjusts this measured temperature as a closed-loop control operation. Parameters other than the temperature can also be measured and subjected to closed-loop control when another sensor is selected. It is also possible to use amperometric sensors or chemical FETs etc. as an alternative to this. Closed-loop control or open-loop control of the actuator 350 and/or of the temperature sensor 300 is performed with the aid of a microcontroller 360 which is likewise electrically connected to the electrical contact elements 30, 40.

Although the invention has been described with reference to preferred exemplary embodiments in this document, it is in no way restricted to said exemplary embodiments, but rather can be modified in various ways. It should further be noted that “a” or “one” does not rule out a large number in this document.

1. A cartridge, comprising:
a housing;
a drum having at least one chamber and electrical contact elements;
an adjustment device configured to rotate the drum about a center axis of the drum; and
electrical conductor tracks arranged on the housing of the cartridge,
wherein the electrical contact elements and the electrical conductor tracks are brought into sliding contact in order to transmit electrical energy.

2. The cartridge as claimed in claim 1, wherein the electrical contact elements are electrically conductively connected to a semiconductor component on a printed circuit board that is coupled to the drum.

3. The cartridge as claimed in claim 2, wherein the semiconductor component is configured to be actuated with the aid of a microcontroller in the closed state of the electrical contact elements with the electrical conductor tracks.

4. The cartridge as claimed in claim 3, wherein, in the closed state of the electrical contact elements with the electrical conductor tracks, the actuation of the semiconductor component by the microcontroller produces variable output of electrical energy to the semiconductor component.

5. The cartridge as claimed in claim 2, wherein the semiconductor component is a heating device arranged in the drum and configured to cyclically heat the chamber, the heating device being configured to be switched for heating purposes by the electrical contact elements making contact with the electrical conductor tracks.

6. The cartridge as claimed in claim 1, wherein the electrical conductor tracks are arranged on the inside of the housing.

7. The cartridge as claimed in claim 1, wherein the electrical conductor tracks are configured as an injection-molded circuit mount in the housing of the cartridge.

8. The cartridge as claimed in claim 2, wherein:
the printed circuit board has at least two tabs at respective ends of the printed circuit board,
one electrical contact element, in each case, is formed on the tabs, and
a first pair of electrical conductor tracks is configured to make contact with the electrical contact elements.

9. The cartridge as claimed in claim 8, wherein:
the printed circuit board has further tabs,
one further electrical contact element, in each case, is formed on the further tabs, and
electrical conductor tracks that are different from the first pair of electrical conductor tracks are configured to make contact with the further electrical contact elements.

10. The cartridge as claimed in claim 1, wherein the electrical conductor tracks are configured to be connected to an energy source in a wire-bound manner or in a wire-free manner so as to, in the closed state of the electrical contact elements with the electrical conductor tracks, generate a flow of current through the electrical conductor tracks.

11. The cartridge as claimed in claim 1, wherein the adjustment device comprises a first bevel that interacts with a second bevel of the drum in order to move the drum from a first position, in which the second bevel engages in an interlocking manner with the housing of the cartridge in the direction of rotation about the center axis, to a second position along the center axis in which the interlocking connection is broken and the drum rotates about the center axis.

12. The cartridge as claimed in claim 1, wherein the electrical conductor tracks are formed on the adjustment device instead of on the housing of the cartridge.

13. The cartridge as claimed in claim 1, wherein the electrical contact elements of the drum are second electrical conductor tracks that are electrically conductively connected to the semiconductor component on the printed circuit board.

14. A method for processing at least one component in a cartridge, the cartridge including a housing, a drum having at least one chamber and electrical contact elements, and an adjustment device configured to rotate the drum about a center axis of the drum, the method comprising:
rotating the drum about the center axis with the adjustment device; and
causing sliding contact between the electrical conductor tracks and the electrical contact elements in order to transmit energy.

15. The method as claimed in claim 14, further comprising:
performing a measurement method with the aid of a measuring apparatus that is supplied with the energy transmitted by the sliding contact.
